(19) United States
(12) Patent Application Publication
(10) Pub. No.: US 2014/0077496 A1
(43) Pub. Date: Mar. 20, 2014

(54) Ocean Wave Energy Converter (OWEC) with Counter-Rotating Flywheels

(71) Applicant: Alfredo Gill Londono, Marietta, GA (US)

(72) Inventor: Alfredo Gill Londono, Marietta, GA (US)

(21) Appl. No.: 13/973,242

(22) Filed: Aug. 22, 2013

Related U.S. Application Data
(63) Continuation-in-part of application No. 13/616,416, filed on Sep. 14, 2012, now Pat. No. 8,574,233.

(51) Int. Cl. F03B 13/18

(52) U.S. Cl. CPC F03B 13/1855
USPC 290/53

(57) ABSTRACT

An OWEC designed to convert the energy of an oscillating water column within a wave into electricity for use during peak hours and into compressed air for use during off peak hours, and to withstand adverse weather conditions. Located off-shore, and submerged about 95%, the OWEC comprises: a vertically adjustable spar comprising a vertical shaft connected to a foundation in the sea floor, and extending above sea level; a float comprising parabolic reflectors on the underside to channel wave flow upward, and two buoyancy chambers to support the float's weight; adjustable parabolic spar reflectors attached near the spar's bottom to re-direct horizontal wave flow vertically to maximize the float's produced power; a cylinder system to generate compressed air that is stored in an onsite tank; and, a power takeoff (PTO) device sitting atop the float and comprising two counter-rotating flywheels to convert the float's power into electrical energy.

### CROSS-REFERENCE TO RELATED APPLICATIONS

This application is a continuation-in-part of U.S. patent application Ser. No. 13/616,416 filed Sep. 14, 2012, by Gill Londono, and entitled “OCEAN WAVE ENERGY CONVERTER (OWEC) WITH PARABOLIC REFLECTORS”, the entire disclosure of which is hereby incorporated by reference.

### FIELD OF THE INVENTION

The present invention relates to renewable energy, in particular an ocean wave energy converter to convert vertical and horizontal oscillating wave flow into compressed air power (e.g. a water powered gas compressor) and electricity.

### BACKGROUND OF THE INVENTION

Ocean Wave Energy Converters (OWEC's) are devices designed to absorb the energy of the vertical, up/down oscillating motion of a wave's water column and convert it into electrical, pressurized air and/or fluid energy. Ocean waves can travel thousands of miles without losing energy. Ideally, OWEC's are located a significant distance offshore in approximately 50 meters or more of ocean depth in order to capture the maximum amount of wave energy. When waves reach a sea floor depth of approximately 50 meters or less, the trough of very large waves runs into the sea floor diminishing the speed, power and height of the wave. The friction against the increasingly shallow sea floor approaching the coast causes the waves to slow and ultimately form a backwash. This backwash opposes and slows the incoming waves' forward motion even further. Energy is thus rapidly lost. OWEC's are designed to harness the power of waves before such energy loss occurs.

OWEC's are generally categorized by the method used to capture the energy of the waves. The primary methods comprise: point absorber or buoy; surfacing following or attenuator oriented parallel to the direction of wave propagation; terminator, oriented perpendicular to the direction of wave propagation; oscillating water column; and overtopping. Point Absorbers OWEC's generate electricity from the bobbing or pitching action of a floating object that is fixed to a device on the ocean floor. They convert mechanical energy from the systems movement into a linear or rotational motion for driving electrical generators. To generate large amounts of energy, a multitude of these devices must be deployed, each with its own piston and power take-off equipment. Oscillating Water Columns (OWC) generate electricity from the wave-driven rise and fall of water in a shaft that drives air in and out of the shaft, powering an air-driven turbine. Moving Body Devices attenuators are aligned along the wave direction and terminators lies across the prevailing direction of wave propagation. The relative movement of different parts of the device is driven by the waves to generate pressure in a working fluid that is connected to a turbine to generate electricity. And in overtopping OWEC's, parabolic reflectors may be used in a coastal system that concentrates the direction of wave flow into an elevated reservoir (i.e. the reflectors push the wave up and over a barrier into a reservoir). Subsequently, when water flows out of the reservoir it generates electricity, similar in manner to a hydro dam.

Prior art OWEC's similar to the preset invention comprise the following systems. The “Bessho” system uses the oscillation of the float due to the waves and converts the mechanical energy into electrical energy. These systems have been shown, though, to damage the float during adverse weather conditions, such as excessively high tide, extraordinarily high waves, and typhoons.

Additionally, US 20040239120 by Yi, Jwo-Hwu, teaches an OWEC with a float and a lever having one end coupled to the float, and a fixed section mounted on a seacoast. The upward motion of the float caused by the impact of waves will move a magnet downward by the lever and compress a resilient means, while a downward motion of the float will move a magnet upward by the lever and expand the resilient means. This repeated movement of the magnet will induce a voltage in the electric coils.

Similarly, U.S. Pat. No. 8,013,462 B2 by Protter et al, discloses a two-body OWEC with a primary body interconnected to a secondary body such that the bodies may oscillate longitudinally relative to one another while a generator is drivingly connected between the two bodies. The OWEC maintains out-of-phase oscillation of the bodies to increase the driving force imparted to the generator and thus the electrical energy output.

And United States Patent Application 20120032444 by J. A. Burton discloses an OWEC comprising devices that convert wave energy directly into rotary mechanical motion, in which the device comprises a wave catcher wheel that relies on wave particle motion, a differential pressure system that operates on a wave amplitude pressure differential, and a wave amplifier that uses the wave surge to focus the surface wave's energy. The wave amplifier in this invention operates primarily at the surface of sea level, and not meters below the surface where untapped wave force occurs.

Additionally, conversion of a float's movement within OWEC's, such as the listed prior art, into electrical energy is difficult because of the slow oscillations of the float riding on the waves. Float based systems also have low efficiencies when attempting to convert alternating linear energy to the unidirectional rotation of a generator shaft.

Therefore there is a need within the OWEC industry for an improved means of increasing the amount of power generated by an oscillating float OWEC and efficiently converting this into electrical energy, while ensuring that the OWEC is safe from damage during adverse weather. The present invention accomplishes this by: (1) utilization of adjustable reflectors in a float/spar type of OWEC to increase the power generated by the float; (2) use of a novel two counter-rotating flywheel system atop the float to directly convert mechanical energy from the upward and downward oscillation of the float into electrical energy; and (3) computerized means of submerging the float during adverse weather to protect it from damage.

### SUMMARY OF THE INVENTION

The OWEC of the present invention primarily comprises (from sea floor to sea level): 1) a spar comprising a vertical shaft affixed to a foundation embedded in the sea floor and extending out of the ocean; 2) adjustable (e.g. rotatable and bendable) spar reflectors attached near the bottom of the spar to re-direct horizontal wave flow upward into a float; 3) a cylinder system to generate compressed air from atmospheric air that is pulled into the cylinders with a float's upward and downward oscillations; 4) an onsite tank for storing the compressed air for use during off peak hours of energy consumption; 5) a float comprising parabolic reflectors on the underside to channel vertical wave flow vertically, thus causing the float to rise upward on the spar, and two buoyancy chambers on opposing sides of the float to support the weight of the float; and, 6) a power takeoff (PTO) device sitting atop the float and comprising a computer system to control the OWEC, as well as two counter-rotating flywheels to convert the float's mechanical-rotational energy into electrical energy.

### Spar

The spar is housed within a foundation embedded in the sea floor. The foundation supports the weight and provides stability to the OWEC, and extends to just below the spar reflectors. The spar extends vertically from the foundation to the sea level to permit only the top of the float and the power takeoff device (PTO) to reside above the sea level.

In one embodiment, the spar comprises multiple segments along its vertical length, with shapes specific to their function, such as: 1) a square structure for maximum material strength from the foundation and through the spar reflectors to an air outlet valve system residing below a cylinder system; 2) a round section from the bottom of the cylinder system to the float for rotating the float and cylinder system, and for piping air from the cylinder system to the onsite tank for storage; and, 3) a threaded screw extending upward from the float through the counter-rotating flywheels that the float travels up and down upon, thus causing the flywheels to rotate and generate electrical energy.

The spar may also move in multiple directions to protect the float and PTO during adverse weather and to maximize the amount of power generated by the float. In one embodiment, the spar may be raised or lowered by means housed within the foundation, such as hydraulic jacks residing beneath the spar reflectors. The spar would be lowered, for example, during adverse weather to submerge and thus protect the float and PTO; and, raised during high waves to maximize the amount of energy generated. In one embodiment, the spar does not rotate around its vertical axis, while OWEC components attached to it can (e.g. the spar reflectors, float, and cylinder system). In another embodiment, the spar can move in all directions.

Spar Reflectors:

The spar reflectors are located near the bottom of the spar for re-directing horizontal wave flow vertically upward to assist the float in rising. Various embodiments of the spar reflectors are encompassed within the present invention, and may comprise two or more essentially flat rectangular or square members whose movement is under the operational control of the PTO's computer system. The reflectors may also be “parabolic” in nature, meaning they may be concavely curved along one or more of their edges to assist in redirecting the water inward and upward versus having it be redirected sideways and around the reflectors.

The spar reflectors may also be adjusted by the computer system by rotating around the spar, and/or bending the members relative to each other and to the horizontal wave flow. During normal conditions, the computer will adjust the spar reflectors to face the oncoming wave flow (i.e. align perpendicular to it) so as to optimize the amount of water that is re-directed upward while minimizing the amount of turbulence produced by the change in direction of water flow. Conversely, during adverse weather conditions, the computer will position the spar reflectors to align them with the horizontal wave flow, and/or to minimize their profile, in order to protect them from damage.

### Cylinder System with Storage Tank

Above the spar reflectors, and in contact with the underside of the float, is a cylinder system for generating energy from the float's movements in the form of compressed air. During Off Peak Hours of energy consumption, the cylinder system is turned on and compressed air is generated and stored, such as in an onsite tank connected by a pipe to the OWEC. Energy from the oscillating waves is converted into highly pressurized air by this invention's usage of a novel cylinder system that works in conjunction with the float's movements. Air inlet valves residing between the bottom of the float and the top of the cylinder system pull atmospheric air into the cylinder system as the float moves upward with the rising wave. Once within the cylinder system, multiple parallel cylinders (e.g. 6, 8, etc.), wherein each cylinder comprises unidirectional air valves (check valves) and two vertically aligned pistons encircled with springs, work to compress the air, and then release it from the bottom of the cylinder system. From there it may be piped for storage, such as in a tank residing on the sea floor. The pressurized air created by the cylinder system can be released from the storage tank as needed to further drive the OWEC's electrical generator or any remote generator for electrical, air and/or fluid energy production.

### Float

The float of the OWEC comprises buoyancy chambers, such as one each on opposing ends of the float. The buoyancy chambers support the float's weight in order to keep only about 5% of the OWEC's float above the sea surface. All prior art systems are built with approximately 50-80% of the OWEC above the sea surface due to the limitations of the way they are constructed. The advantage of the much greater degree of submersion of the current invention over prior art systems is to prevent damage to the OWEC from surface waves, especially during storm conditions.

The float of the present invention further comprises reflectors on the underside of the float for receiving the upward column of water being generated by the spar reflectors, and to channel the flow of water upward against the float's bottom surface. This flow thus increases the power with which the float is pushed upward, as compared to the prior art floats of merely riding a wave upward/downward. And the increase in power correlates with an increase in electrical energy production.

The OWEC also comprises means for raising and lowering the float under the operational control of the PTO computer. For example, the computer system may control hydraulic jacks housed within the spar, or other electro-mechanical means that operate to raise or lower the spar, and thus the float as needed (e.g. during a storm the float is lowered beneath the surface of the water to protect it from damage due to high winds and high pressured waves; during high tide the float is raised; and, during low tide it is lowered so as to maintain approximately 95% float submersion).

### Power Takeoff Device (PTO)

A PTO resides above the float that comprises: 1) a flywheel system to convert mechanical energy into electrical energy; and, 2) a computer system, onsite or offsite, to electronically control the functions of the OWEC, such as: the positioning of the spar reflectors to optimize the amount of horizontal wave flow that is re-directed upward into the float; to switch the OWEC between the generation of electrical energy by the flywheels to compressed air by the cylinder system; to protect the OWEC during adverse weather conditions by lowering the float and aligning the spar reflectors with the direction of horizontal wave flow; etc.

Flywheels:

the flywheel system comprises two counter-rotating flywheels threaded to a vertically-oriented screw of the spar that extends through and above the float. A nut, residing within the flywheels and encircling the screw, converts the linear up and down motion of the float's movements into rotational movement of the flywheels (i.e. the nut rotates in one direction when the float is moving up and in the opposite direction when the float is moving down). An overrunning clutch on each flywheel (i.e. two total) ensures that the flywheel rotates in one direction only. The clutch connects each flywheel with the nut only when the nut and the flywheel are rotating in the same direction; otherwise, it disconnects them. When the flywheels are rotating in opposite directions, one is acting as the stator and the other as the rotor to generate electrical energy, irrespective of the direction that the float is traveling in. The produced electrical energy is then stored onsite or removed to remote locations (e.g. shore or sea platform) by means well known in the art.

This invention with its several preferred embodiments can be understood from a full consideration of the following specification including drawings, detailed description, and claims. These and other features, aspects, and advantages of the present invention will become better understood with reference to the following detailed description. This summary is provided to produce a selection of concepts in a simplified form. This summary is not intended to be used to limit the scope of the claimed invention.

### BRIEF DESCRIPTION OF THE DRAWINGS

The present invention will now be described more fully hereinafter through various embodiments in reference to the accompanying drawings comprising:

FIG. 1 is a front view (i.e. aligned with direction of horizontal wave flow) of the OWEC with the spar reflectors positioned to optimize upward water flow in normal weather conditions.

FIG. 2 is a side view of the OWEC in the same position as FIG. 1.

FIG. 3 is a front view of the OWEC during adverse weather conditions.

FIG. 4 is a side view of the OWEC in the same position as FIG. 3.

FIG. 5 is a side view of the top portion of the OWEC comprising the cylinder system in the bottom position, the float, and the flywheels of the power takeoff device (PTO).

FIG. 6 is a cross-sectional view of a projection line dissecting the view of FIG. 5 comprising the float and flywheels.

FIG. 7 is a front perspective view of the float.

FIG. 8 is a rear perspective view of the underside of the float.

FIG. 9 is a front plain view of the float.

FIG. 10 is top view of the float comprising a cross-sectional view of the projection line “10” in FIG. 9.

FIG. 11 is a side view of the mid-section of the spar in the absence of the cylinder system.

FIGS. 12-20 illustrate different embodiments and positions of the spar reflectors.

FIG. 12 is an elevated perspective view of the spar reflectors positioned to maximize the amount of horizontal wave energy that is re-directed upward towards the float.

FIG. 13 is a front perspective view of the underside of the spar reflectors in a position to minimize contact with the oncoming horizontal wave.

FIG. 14 is a side view of the spar reflectors configured in FIG. 13.

FIG. 15 is a side view of an embodiment of the OWEC enabling the spar reflectors to move vertically as the spar does.

FIGS. 16-18 illustrate an embodiment of the parabolic spar reflectors with concavely curved outer edges.

FIG. 16 is a view of a bottom parabolic spar reflector with a middle fixation member.

FIG. 17 is a view of another embodiment of a bottom parabolic spar reflector with a half circular cutout in lieu of a fixation member.

FIG. 18 is the top and bottom parabolic spar reflectors mounted on the spar and in an upright position.

FIGS. 19-20 illustrate another embodiment of the spar reflectors comprising two side members flanking a middle reflector member.

FIG. 19 is a front perspective view of the three member spar reflector embodiment.

FIG. 20 is a rear underside perspective view of the three member spar reflector embodiment.

FIGS. 21-24 illustrate various features of the cylinder system that produces compressed air.

FIG. 21 is a side view of the cylinder system when the cylinders are in an intermediate position.

FIG. 22 is a cutaway view of a top of the cylinders demonstrating the pulling of atmospheric air into the cylinders.

FIG. 23 is a cutaway view of the bottom of the cylinder system demonstrating the pushing of compressed air or liquid out of the system.

FIG. 24 is a cutaway view of one cylinder within the exemplified six cylinder system.

FIG. 25 is an illustration of a tank storing compressed air/liquid produced by the cylinder system.

FIG. 26 is a flowchart of steps of the OWEC in generating, storing, and transporting electricity and compressed air.

### REFERENCE NUMERALS

Parts contained in the figures are referenced with the following numerals:
Item 2 represents the float;
Items 3a,b represent the two counter-rotating flywheels;
Item 4 represents the spar, and 4a-c the square, circular, and screw segments of the spar, respectively;
Item 5 represents the foundation that connects the spar to the sea floor.
Item 6 represents a two member spar reflectors, wherein 6a,b represent respectively, the bottom and top members of the reflectors, and 6c represents the middle fixation member;
Item 7 represents a three member parabolic spar reflectors requiring a middle fixation member 6c, and wherein 7a,b represent, respectively, the bottom and top members of the reflectors;
Item 8 represents parabolic spar reflectors with a half circular cutout in lieu of a fixation member;
Item 9 represents a three member parabolic spar reflector comprising side members 9a,b flanking a middle member 9c.
Item 10 represents the cylinder system;
Item 11 represents one cylinder within the exemplified six cylinder system;
Item 12 represents the stationary bar residing beneath the cylinder system;
Items 14a,b represent the bottom and top pistons within each cylinder;
Items 15a-c represent each check valves nut, spring, and ball, respectively;
Items 16a,b represent the bottom and top piston check valves;
Items 17a,b represent the bottom and top cylinder check valves;
Items 18a-d represent the air inlet assembly attached to the bottom of the float, wherein 18a,b are the right and left air inlet vertical tubes, respectively, 18c is the apparatus attached beneath the float attaching the tubes 18a,b, and 18d are the holes to let air into each cylinder;
Items 19a,b represent a spring encasing the bottom and top pistons 14a,b within the cylinder system;
Item 20 represents the piston rod within the cylinder system;
Item 21 represents the air channel running through the cylinder system, bar, and to the air outlet;
Item 22 is the air outlet from the bottom of the cylinder system to the tank;
Items 26a,b represent the float's left and right buoyancy chambers, respectively;
Items 28a,b represent the float's left and right parabolic reflectors, respectively;
Item 29 represents the flow of ocean water into the front of and out the back of the float;
Item 30 represents the onsite tank where compressed air is stored;
Item 34 represents the outlet from the tank when the compressed air is released;
Item 36 represents the water inlet valve on the bottom of the tank;
Item 38 represents the nut to which the flywheels are attached; and,
Items 40a,b represents the overrunning clutch attached to each flywheel.

### DETAILED DESCRIPTION OF THE INVENTION

### Adverse Weather

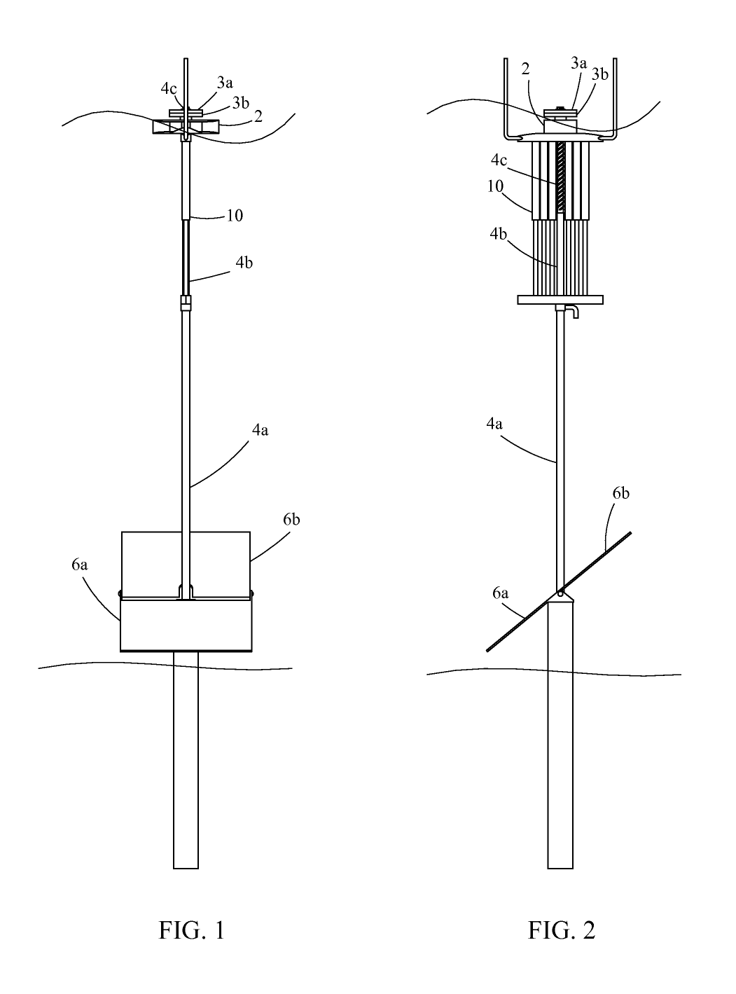

The OWEC of the present invention has the advantage over prior art OWEC's of being able to protect the OWEC during adverse weather conditions. For example, FIGS. 1-4 illustrate the ability of the PTO's computer system to reposition the OWEC's float 2 and the spar reflectors 6a,b depending on the weather conditions. FIGS. 1 and 2 are the OWEC's front and side views, respectively, during normal weather conditions. The float 2 is extended to the spar's top section 4c, while the spar reflectors 6a,b are in the fully extended position and angled about 30-40 degrees from the horizontal wave flow to optimize the amount of water re-directed upward while minimizing the amount of turbulence produced.

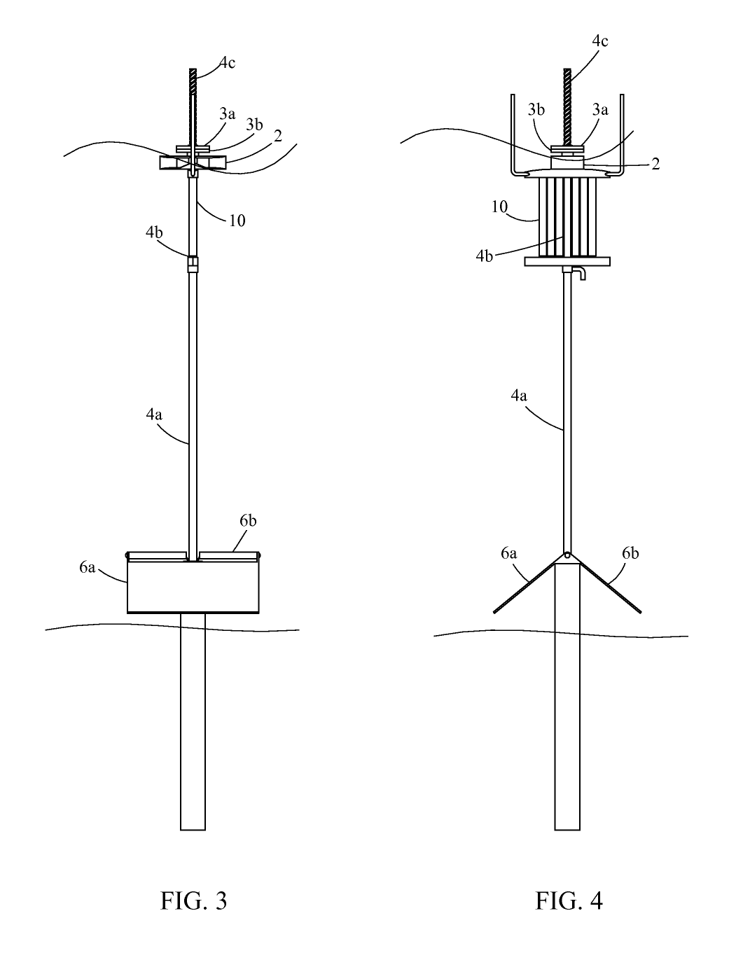

Likewise, FIGS. 3 and 4 illustrate the OWEC during adverse weather conditions with the float 2 lowered on the spar section 4c, and the spar reflector 6b rotated to a position that is approximately 90 degrees from its upward position shown in FIGS. 1 and 2. In this position, the OWEC is able to protect the float 2 and the spar reflector's 6a,b from damage due to the high winds and powerful waves.

### Float

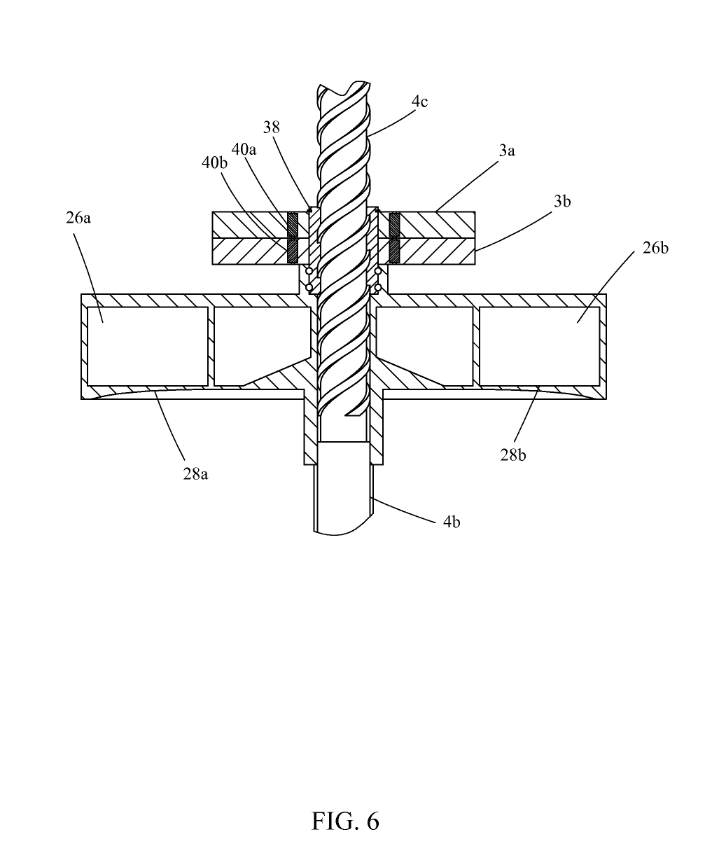

Energy is generated when the ocean waves cause the float 2, as illustrated for example in FIGS. 6-10, to rise and fall, which in turn causes the flywheels to rotate and generate electrical energy. The amount of energy produced is enhanced in the float of the present invention via: 1) the spar reflectors pushing more wave energy vertically towards the float as compared to a normal wave; and, 2) parabolic and/or concave reflectors located on the underside of the float that channel up-surging waves towards the center of the float, thus pushing it up in a vertically direction along the spar. Both of these OWEC structural features cause an increase in the amount of power with which the float rises, and thus the amount of electrical energy produced by the flywheels that rotate in direct response to the float's upward and downward movements.

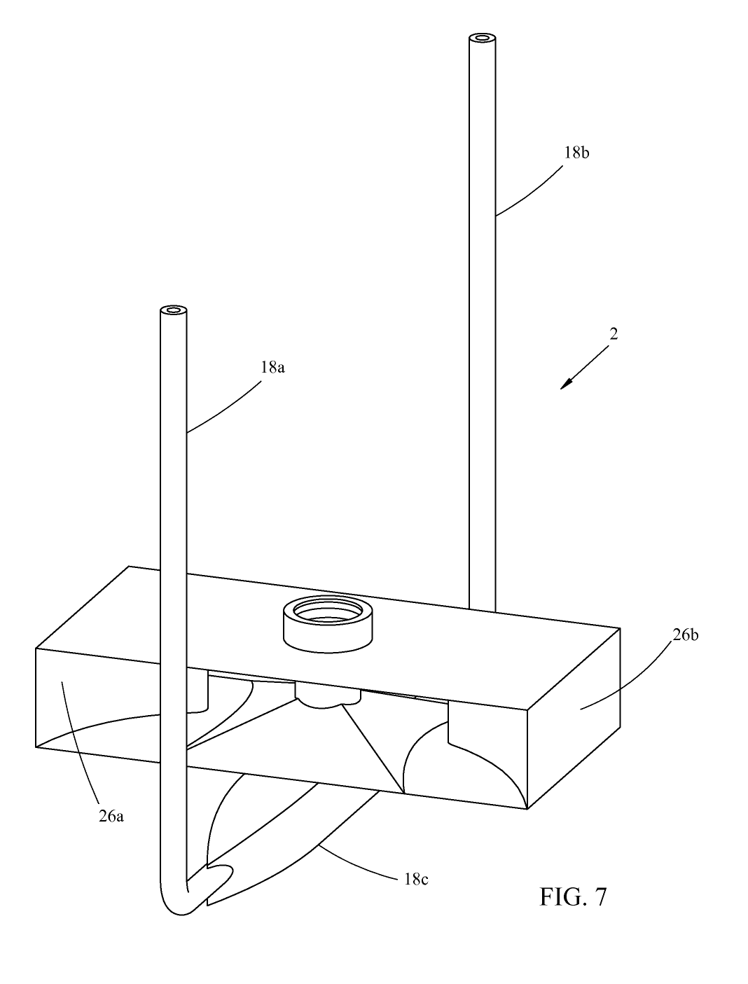

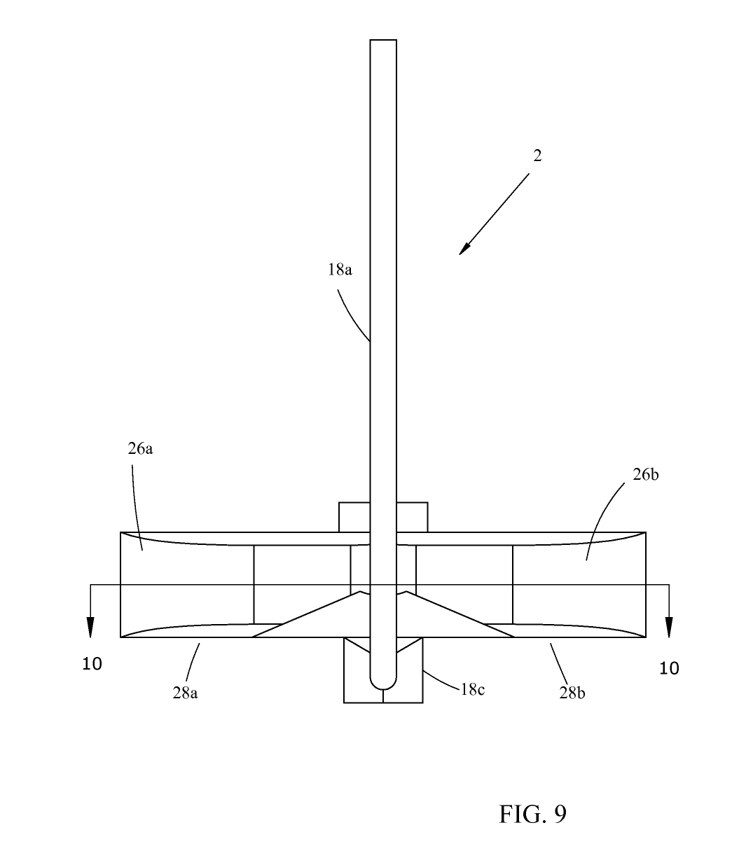

The float comprises an essentially rectangular structure (e.g., about 30 meters wide×8 meters height×13 meters long), that is made in one embodiment of reinforced concrete. It may further comprise built-in buoyancy chambers to support the weight of the float in order to maintain approximate 5% of its volume above sea level. As shown in FIGS. 7 and 9, the float 2 may comprise a buoyancy chamber 26a,b on opposing sides or ends of the float 2.

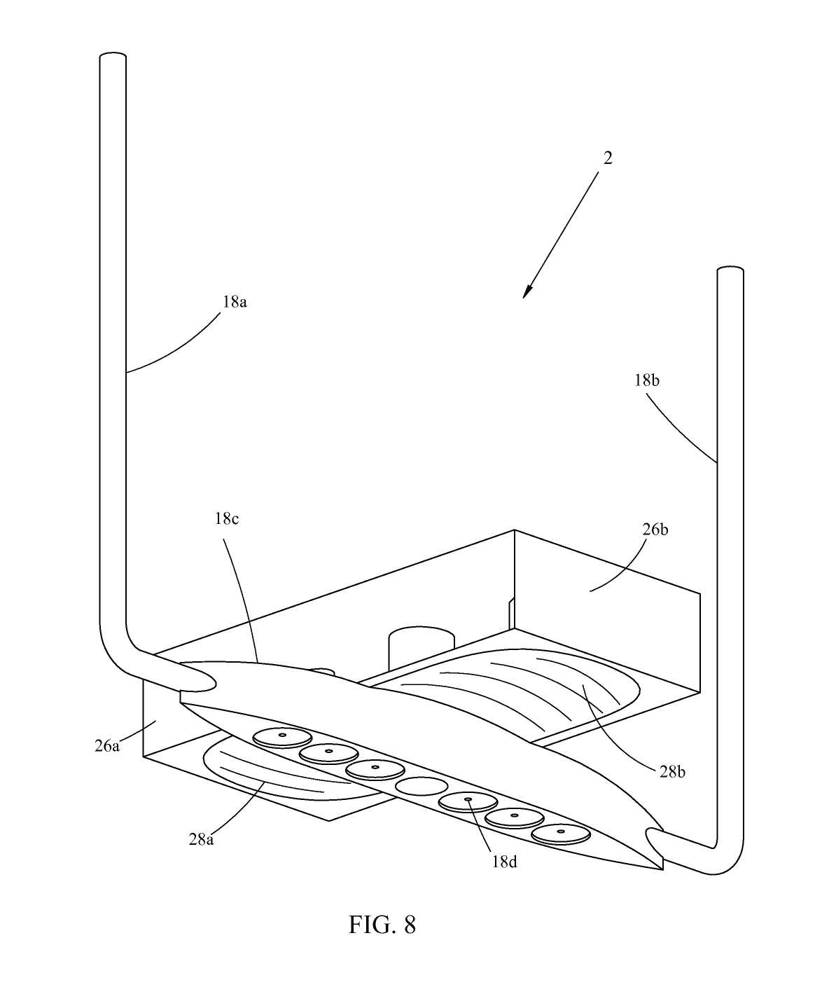

The float may also comprise parabolic reflectors located on the undersurface of the float to channel the wave upward and inward against the float's bottom surface in order to increase the power with which the float rises. In one embodiment, as shown in FIGS. 8 and 9, two parabolic reflectors 28a,b reside on the undersurface of the float 2, and may be shaped with inward curvature, or in a concave manner.

The float may further comprise means for sucking atmospheric air into the cylinder system. In one embodiment, as shown in FIGS. 7-9, the means may comprise an air inlet tube system that extends vertically above the float into the ocean air, and attaches to the OWEC beneath the surface of the ocean—between the underside of the float and the top of the cylinder system. The air inlet system may further comprise two tubes 18a,b that extend vertically above the ocean surface for atmospheric air to be sucked into the tubes, and that connect to an apparatus 18c sitting atop the cylinder system comprising a hole 18d for each cylinder to draw the air into the cylinder system.

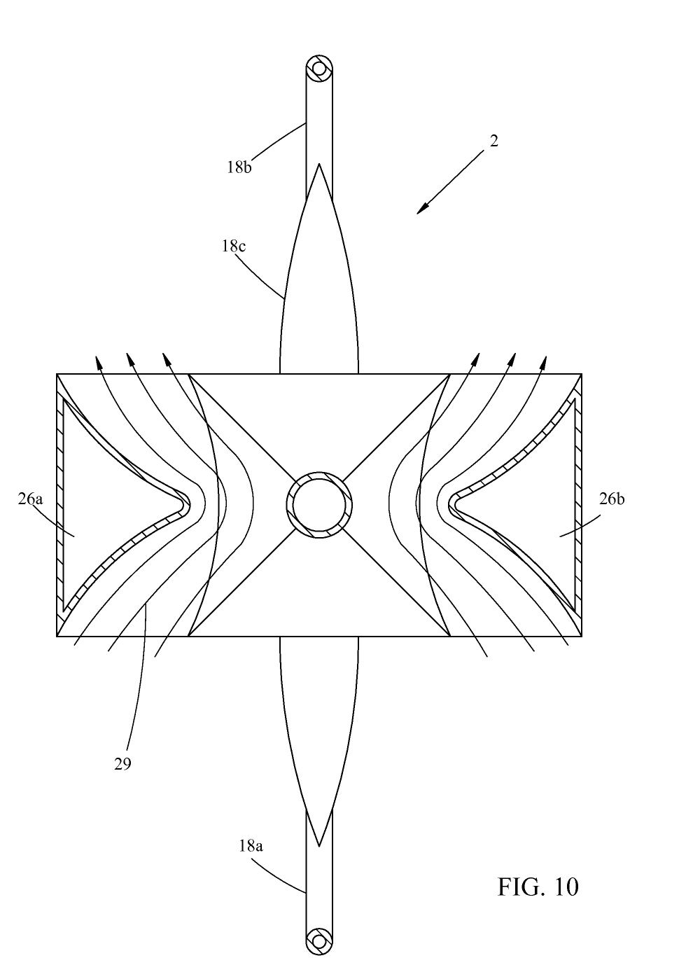

FIG. 10 provides an overhead, top view of a cross section of the float through a projection line “10” as shown in FIG. 9. The arrowed lines 29 within the float 2 represent the flow of ocean water into, within, and exiting the float as it rises and falls with the oscillating wave flow.

### Counter-Rotating Flywheels

Sitting atop and joined to the float, are two counter-rotating flywheels 3a,b as shown in FIGS. 1-5, and in as a cross-sectional view in FIG. 6. As seen in FIG. 6, the flywheel system comprises two counter-rotating flywheels 3a,b threaded to a vertically-oriented screw 4c of the spar that extends through and above the float 2. A nut 38, residing within the flywheels 3a,b and encircling the screw 4c, converts the linear up and down motion of the float's movements into rotational movement of the flywheels (i.e. the nut rotates in one direction when the float is moving up and in the opposite direction when the float is moving down). An overrunning clutch 40a,b, one each attached to a flywheel, ensures that each flywheel rotates in one direction only; and it connects each flywheel with the nut only when the nut and the flywheel are rotating in the same direction; otherwise, it disconnects them.

When the flywheels are rotating in opposite directions, one is acting as the stator and the other as the rotor to generate electrical energy, irrespective of the direction that the float is traveling in. The stator flywheel has permanent magnet(s) or electromagnet(s) to generate a magnetic field when the flywheels rotate. The rotor flywheel has coils to generate electrical current. During counter rotation of the flywheels (i.e. they rotate in opposite directions relative to each other whenever the float rises up or down on the spar's screw), coils of the rotor flywheel cross the magnetic field of the stator flywheel and produce an electrical current in the coils that is stored onsite or transmitted to another location (e.g. shore) for storage and/or consumption by means well known in the art (see also FIG. 26).

### Spar

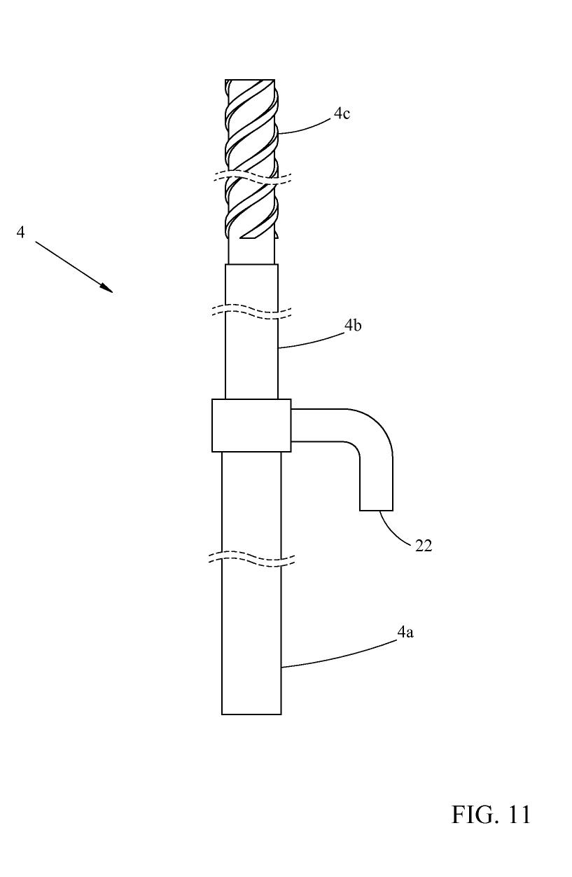

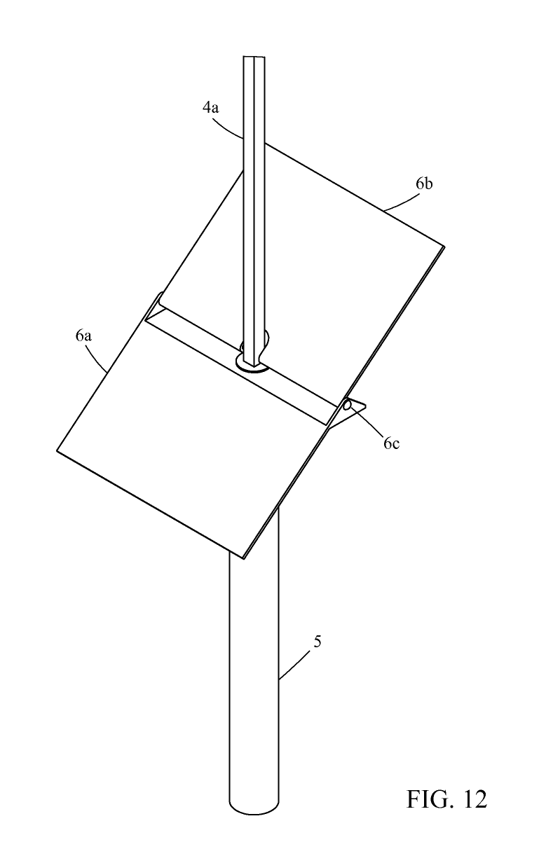

The spar 4 of the present invention, as exemplified in the figures (e.g. FIGS. 1-4 and 11), may have multiple segments along its vertically length to accommodate the different functions of the spar. For example, as seen in FIGS. 1-4 and 11, a square structure 4a may support the base of the spar 4 that is attached to the foundation embedded in the ocean floor. This square structure gives maximum material strength to the spar as it extends through the spar reflectors 6a,b to an air outlet valve system 22 residing below a cylinder system 10 that produces compressed air.

The spar then comprises a round section 4b extending from the bottom of the cylinder system 10 through the float 2 for rotating the float and cylinder system clockwise and counterclockwise to face the oncoming waves (during normal operating conditions). Within this round section 4b comprises a hollow passage for piping air from the cylinder system 10 to the air outlet system 22 for storage in the onsite tanks.

And extending from the bottom of and through the float, and through the counter-rotating flywheels, is the screw section 4c of the spar. The threads on the screw enable the nut of the flywheels and the float attached to the underside of the flywheels to travel as one unit up and down the spar with the oscillating waves to generate electrical energy.

### Spar Reflectors

The present disclosure illustrates various embodiments of the present invention's spar reflectors in which the reflectors rotate counterclockwise or clockwise around the spar (from a top view) to accommodate to changes in the direction of the wave flow and weather conditions. They may also be rotated upward or downward (e.g. relative to the vertical position of the spar) to alter the angle of impact and the amount of surface area of the spar reflector that is contacted by the oncoming horizontal wave. They may also be rotated in almost any direction to minimize the amount of turbulence produced when the horizontal waves impacts the spar reflectors. For example, by bending the top reflector backward relative to the bottom reflector, the amount of turbulence can be reduced while still maintaining some vertical wave movement.

Adjustment of the spar reflectors is also under the operational control of the PTO's computer system residing above the flywheels or in communication with the OWEC by means well established in the industry (e.g. satellite communications, fiber optic cable, etc.). The computer system may be programmed to receive real-time data on weather and current conditions. The OWEC may also comprise a manual override of the computer system, which may be used in various situations, such as testing or fine tuning the positioning of the reflectors, or when a computer malfunction or shutdown occurs, or when erroneous data on weather and current conditions is received and/or computed by the computer system.

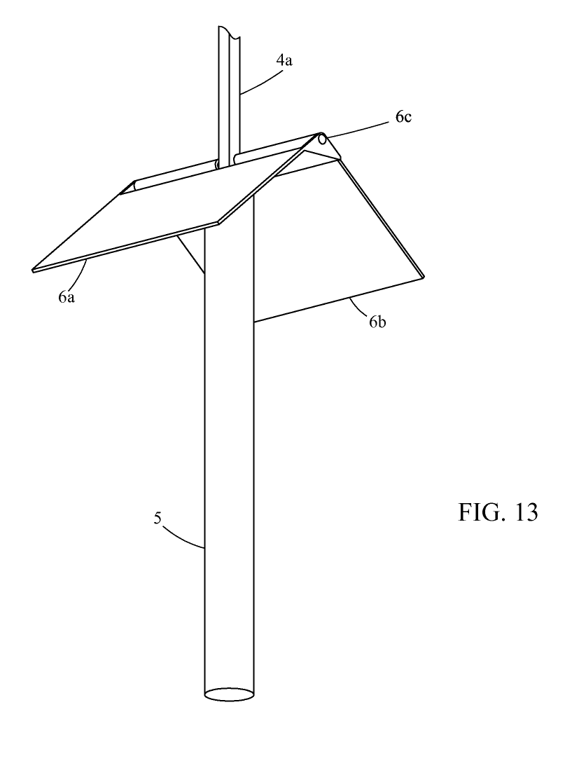

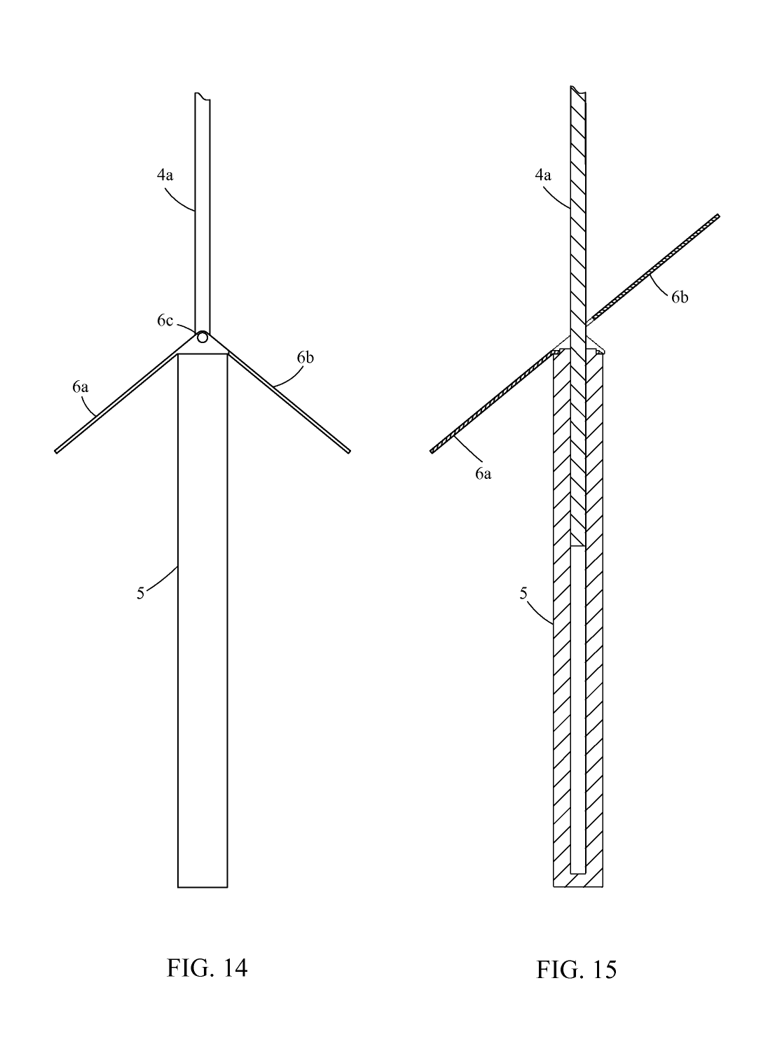

FIGS. 12-20 illustrate different embodiments of two and three member spar reflector assemblies, and their positions on or encircling the spar. In FIG. 12 the spar reflectors 6a,b are: essentially rectangular in shape; they may be sized approximately 50 meters deep by 30 meters wide by 30 meters high; and they are positioned near the bottom of the spar 4a and above the foundation 5 to face the oncoming wave, so as to maximize the amount of horizontal wave energy that is re-directed upward towards the float. FIGS. 3, 4, 13 and 14 illustrate a situation requiring the spar reflectors to minimize contact with the oncoming horizontal wave, such as during adverse weather conditions, by downwardly rotating the reflector 6b, while maintaining or slightly raising the reflector 6a so that it is able to redirect the horizontal wave vertically without creating excessive turbulence.

The spar reflector assembly may additionally comprise a fixation member 6c that is essentially the same length as the reflectors 6a,b, and that encircles the spar (i.e. via a hole cut in the middle of the fixation member that the spar passes through). This fixation member 6c may further comprise mechanical means to fix the inner side of both of the spar reflectors to it and in a manner that permits the reflectors to rotate upward and downward (e.g. see FIGS. 12-14, 16, and 18). Means may comprise, for example, pivots, pins, axes, and/or hinges.

And as illustrated in FIG. 15, the spar reflectors 6a,b can be raised or lowered by raising or lowering the spar 4a, which is housed within the foundation 5. The spar can be lifted during situations such has high waves, via means not shown, such as via a hydraulic jack residing below the spar 4a and within the foundation 5.

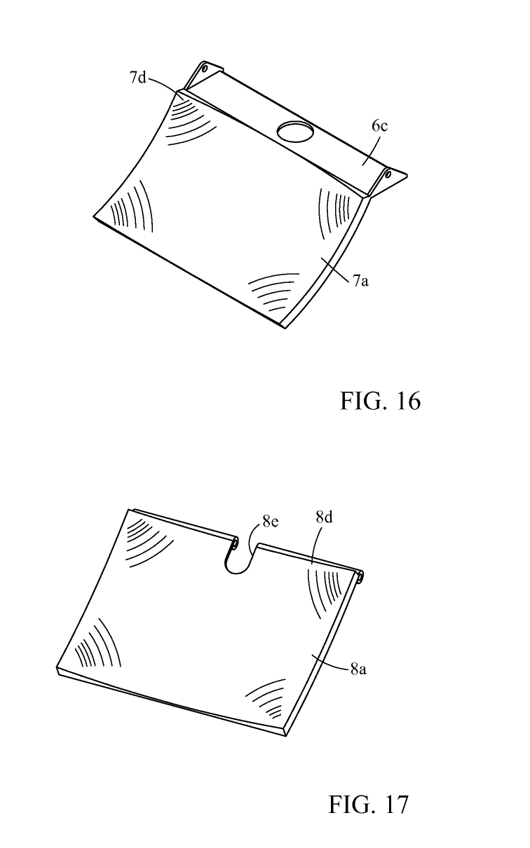

Another embodiment of the spar reflectors is illustrated in FIGS. 16 and 18 and comprises essentially rectangular parabolic spar reflectors 7a,b, and with each reflector further comprising curved or parabolic or concave outer edges that assist in directing water flow against the middle of the reflector versus spilling over the outer edges of the reflector. FIG. 16 is a view of the bottom parabolic reflector 7a attached to the middle bracket 6c along the reflector's inner edge 7d. FIG. 18 is the top and bottom parabolic spar reflectors mounted on the spar and in an upright position.

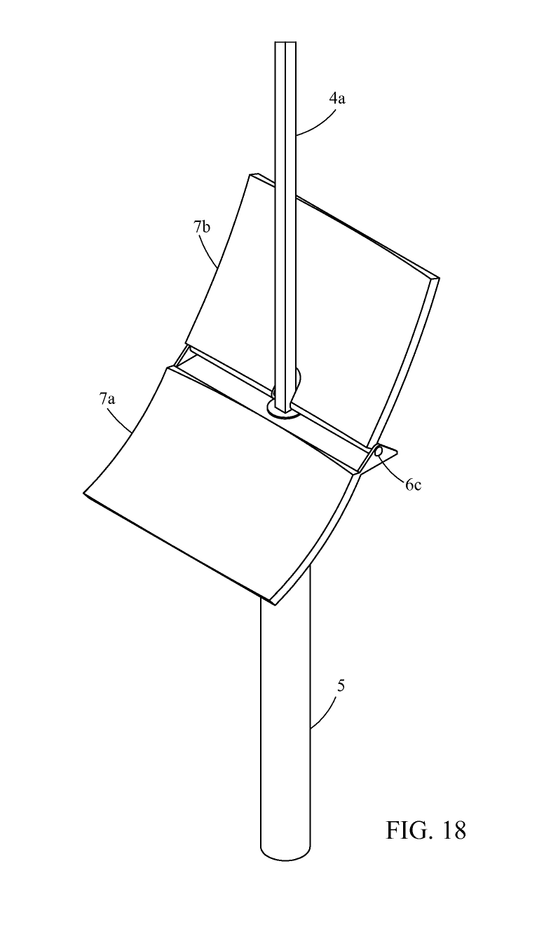

FIG. 17 is another embodiment of the parabolic spar reflector 8a that does not require the middle bracket. Instead, a half circular cutout 8e resides on the reflector's inner edge 8d. A pair of reflectors are then affixed to the spar at 8e, or they are affixed to each other and encircling the spar at 8e. In either manner, the affixed reflectors are able to rotate upward and downward under the operational control of the OWEC computer system.

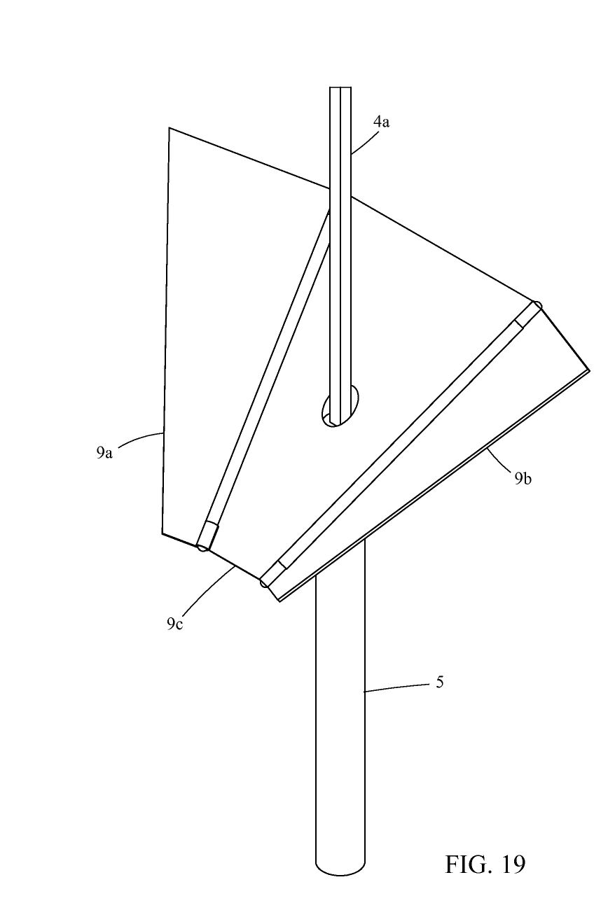

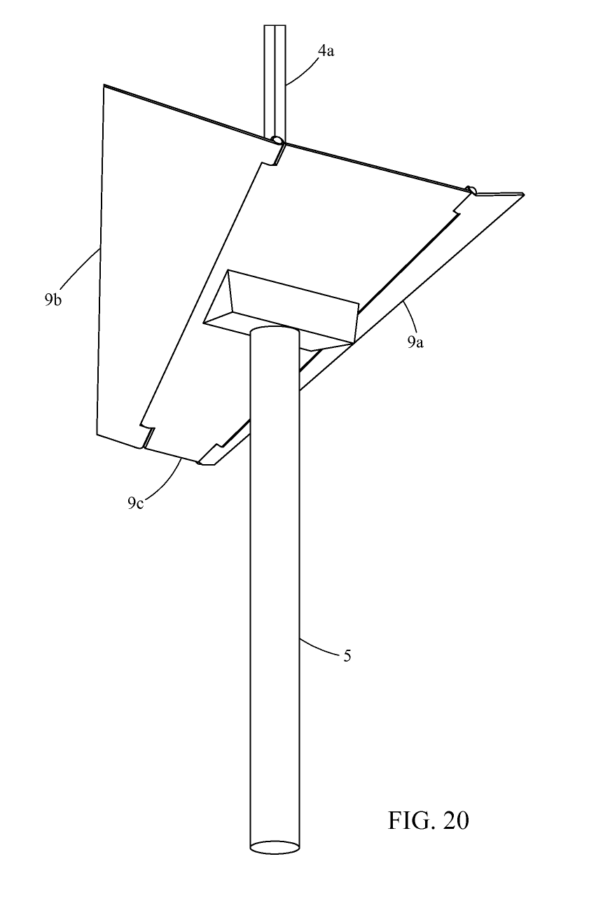

FIGS. 19-20 illustrate another embodiment of a three member parabolic spar reflectors system comprising two side members 9a,b flanking a middle reflector member 9c. The middle member 9c is able to rotate around the spar 4a and foundation 5 to position the spar reflectors to face the oncoming horizontal wave flow, and member 9c is able to rotate upward and downward to maximize the amount of wave flow that is re-directed vertically towards the float while minimizing the amount of turbulence generated. Additionally, the side members 9a,b are able to rotate upward and downward relative to the middle member 9c. Upward rotation increases the parabolic nature of the spar reflectors for the purpose of channeling the wave into the reflector to assist in re-directing it vertically.

### Cylinder and Compressed Air System

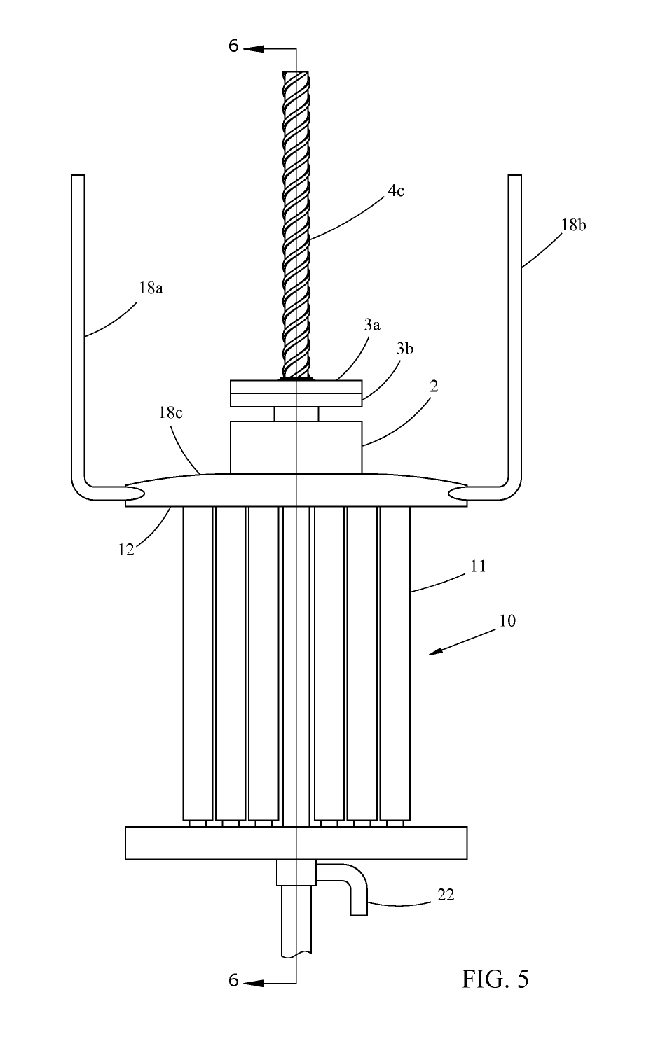

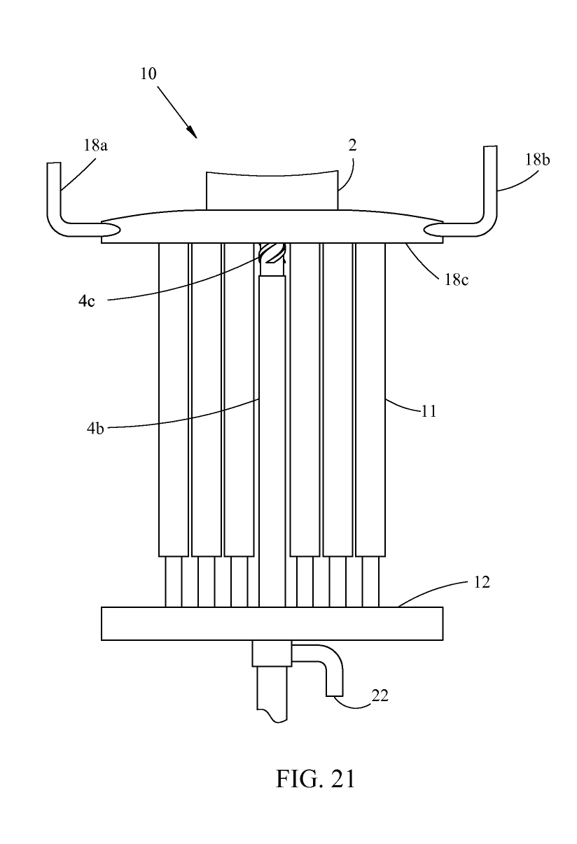

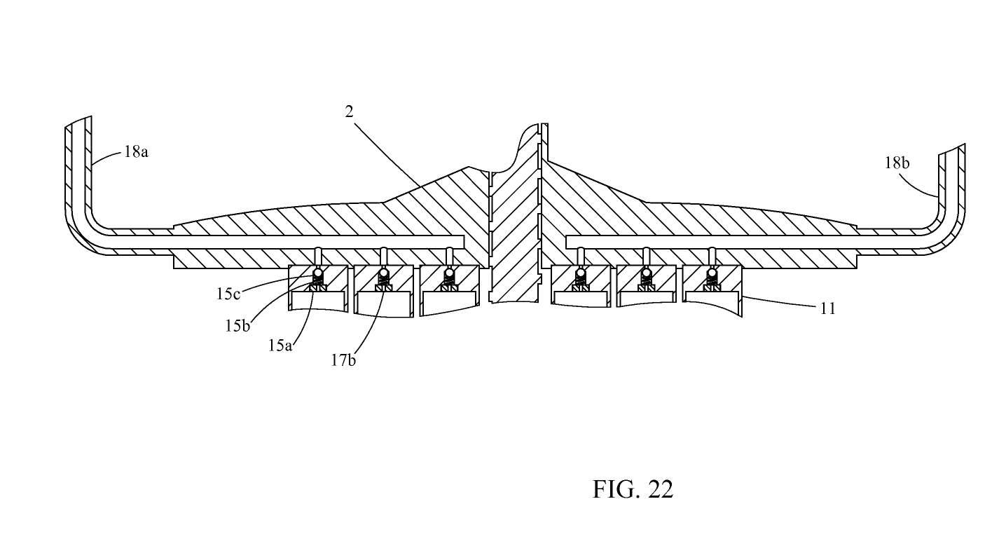

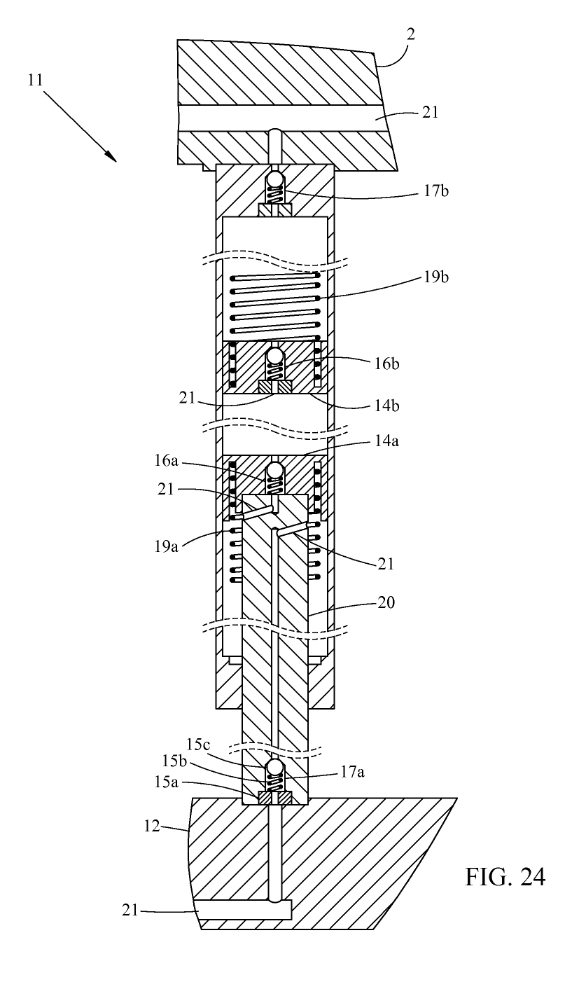

While the float's upward and downward movements are used to generate electrical energy in conjunction with counter-rotating flywheels, the present invention further comprises a cylinder system utilizing the float's movements in order to generate compressed air as another alternative form of stored energy. FIGS. 5 and 21-25 illustrate the primary features of the cylinder system 10 of the present invention that produces compressed air during the various positions of the cylinder system as it moves upward and downward with the float. As illustrated in FIG. 21, the cylinder system 10 resides below and is affixed to the float's air inlet assembly, which draws atmospheric air into the air inlet assembly 18a-c when float 2 rises. (See also FIG. 8 illustrating the underside of the assembly 18c comprising holes 18d for pulling the atmospheric air simultaneously into each cylinder 11). The air passes through each cylinder 11 within the system 10 via an air channel during which time the air is compressed as the float and cylinder system drops against a fixed bar 12. As seen in FIG. 24, the compressed air is released from each cylinder 11 via air channel 21—that the runs from the bottom of each cylinder 11 through the check valve 17a—into the bar 12 comprising the air channel 21, and out through the air outlet 22 and to the storage tank 30.

FIG. 24 is a cutaway view of one cylinder in the exemplified six cylinder assembly 10, although it is noted that the assembly 10 may comprise more or less than 6 cylinders of an even number (i.e. 4, 8, 12 . . . cylinders). Each cylinder 11 of the cylinder system 10 comprises: two vertically aligned pistons 14a,b within each cylinder 11 that enables the air to be compressed from both the top and bottom sides. The lower piston 14a in each cylinder 11 does not move and is affixed to the piston rod 20 that is subsequently affixed to the bar 12, while the top piston 14b moves in conjunction with the movement of the float 2.

Each piston further comprises a bottom and top check valve 16a,b; and, each cylinder 11 comprises a bottom and top check valve 17a,b, respectively. These unidirectional check valves open and close in response to the amount of air pressure exerted on them, and may each further comprise a nut, spring, and ball (see FIGS. 22-24, 15a-c).

And each cylinder 11 comprises a bottom spring 19a and a top spring 19b, each encasing their respective piston 14a,b. The springs function to impede the movement of the pistons upward and downward against the ends of the cylinder.

The method of producing compressed air in the cylinder system 10 generally comprises two stages: Stage 1 occurs when the float and cylinder system are moving downward as the sea level falls; and, Stage 2 occurs when the float and cylinder system are moving upward as the sea level rises, both of which occur within the top, middle, and bottom sections of each cylinder 11.

When the cylinder system 10 is moving downward in Stage 1, air pressure in the bottom section of each cylinder 11 (i.e. between bottom of the cylinder 11 bottom piston 14a) will be reduced and the bottom check valve 17a will close. Then, air pressure in middle section (between top and bottom piston 14a,b) will grow and the top piston check valve 16b will close. And then, air pressure in the top section (between top of the cylinder 11 and the top piston 14b) will grow and the top check valve 17b will close. When the air pressure in the middle section increases enough to open the bottom piston check valve 16a, then some air from the middle section will go to the bottom section. And when air pressure in the top section increases enough to open the top piston check valve 16b, some air from the top section will go to the middle section. During this process, the top surface of the bottom piston 14a will contact the bottom surface of the top piston 14b (i.e. the pistons will meet). Also the top of the top spring 19b will contact top of the cylinder 11 and function to reduce the impact between the top piston 14b and top of the cylinder 11. And the air movement between top and middle section can add to slowing down the movement of the float 2.

During Stage 2, the float 2 and the connected cylinder system 10 are moving upward with the rise of the sea level. When each cylinder 11 is moving upward, air pressure in the bottom section of the cylinder will grow and bottom check valve 17a will open, and resulting in compressed air from bottom section being released to the tank 30 via the air outlet 22. Then air pressure in the middle section will be reduced and bottom piston check valve 16a will close.

For this system to work, the pressure difference required to open the top check valve 17b must be larger than the pressure difference needed to open the top piston check valve 16b. Air pressure in the middle section will be reduced and the top piston check valve 16b will open. Air will then move to the middle section from the top section. Air pressure in the top section will be reduced and top check valve 17b will open. Air will then move to the top section from the float's air inlet 18 into the air channel 21 and from the top section to the middle section of the cylinders. During this process the bottom piston 14a will separate from top piston 14b. The bottom spring 19a will contact the bottom of the cylinder 11 to reduce the impact between the bottom piston and bottom of the cylinder. Air movement between the top and middle sections can also add to slowing up movement of the float upward.

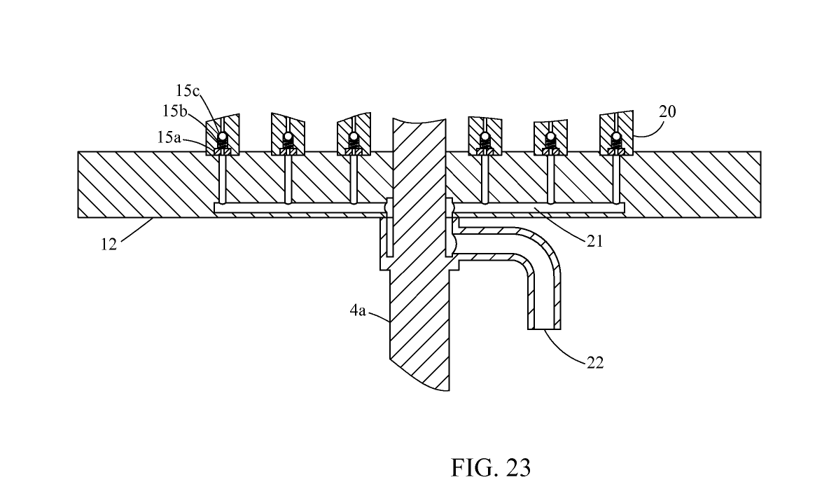

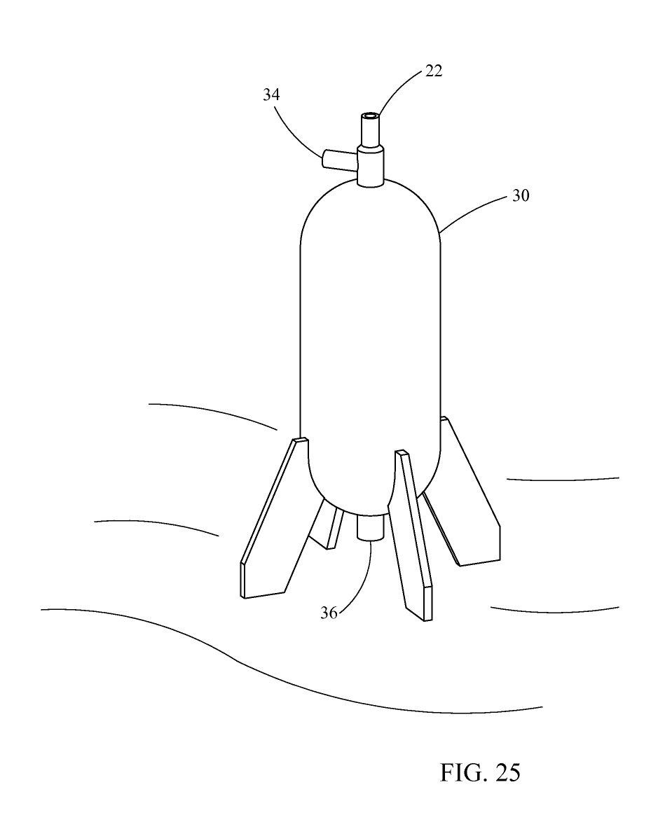

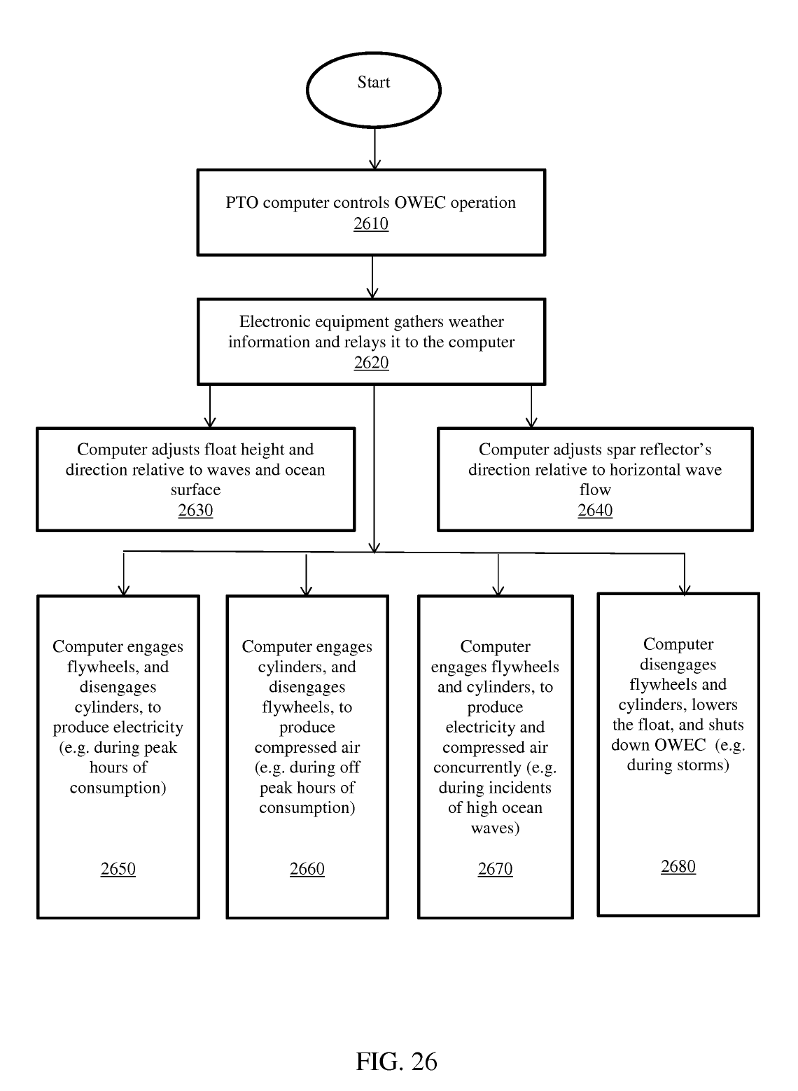

The compressed air may be stored in a tank 30 which is co-located with the OWEC, as illustrated in FIG. 25. The air outlet 22 is the connection between the cylinder system 10 for transporting the air from bottom of the cylinder system 11 to the tank 30 (see FIGS. 23 & 25, 22). The compressed air is then stored in the tank 30 until it is transported through outlet 34 to another location to be utilized as a source of mechanical energy.

In another embodiment, the tank may have a water inlet, such as on the bottom of the tank. When air is added to the tank from the air outlet 22, then water is pushed out through the inlet 36; and, when air is used and exits the tank at outlet 34, then water is drawn into the tank at inlet 36. This enables the tank to reside deep in the ocean, while maintaining a pressure in a tank that is constant and equal to the water pressure outside the tank.

### Computerized Method of Generating Electricity and Compressed Air from the OWEC

FIG. 26 is flowchart of the steps in generating, storing, and transporting electricity and compressed air that is created by the OWEC of the present invention, wherein one or more of the steps may occur sequentially or concurrently. In step 2610, a computer that is located either onsite (e.g. as part of the PTO), or at a remote location (e.g. shoreline, sea platform, etc.), and that is in communication with the OWEC (e.g. satellite), controls the OWEC device by transmitting commands to the OWEC computer server. Through these computer commands it can control all aspects of the OWEC's ability to generate electricity and compressed air, such as opening and/or rotating the spar reflectors, raising or lowering the float, and turning on/off the generation of electricity by turning on/off the flywheels, etc.

In step 2620, the electronic equipment within the OWEC computer of step 2610 electronically collects information pertaining to weather conditions near the OWEC, and enters this information into the computer algorithm that controls the OWEC.

In step 2630, and in normal fair weather conditions, the OWEC is lowered or raised until about 5% of the total height or volume or surface area of the float extends above the surface of the water. But, in dangerous conditions, such as during storms when the wave height may rise to about 20 meters or more, the OWEC may be lowered beneath the surface of the water to protect it (also see step 2680).

In step 2640, and in normal fair weather conditions, the computer opens the spar's reflectors and rotates them so that they are aligned perpendicularly to the oncoming horizontal flow of seawater generated by the waves. When the seawater makes contact with the spar reflectors, it is directed upward towards the OWEC's float. But, if the weather is severe and the ocean turbulent, then the computer can remotely act to close, bend, or otherwise rotate the spar reflectors to minimize their contact with the oncoming horizontal wave flow so as to prevent them from being damaged.

In step 2650, the computer engages the flywheels within the PTO device that is sitting atop the float to generate electricity, while concurrently closing the cylinder system that is used to generate compressed air.

In step 2660, the computer disengages the flywheels and activates the cylinder system for producing and storing compressed air. The compressed air can be stored onsite during Off Peak Hours of energy consumption, and then released to the auxiliary generator for additional energy production during Peak Hours.

In step 2670, the computer directs both of the flywheels within the PTO and the cylinder system to work concurrently. Both systems for energy production would be deployed, for example, during incidents of large waves.

In step 2680, the computer directs both the flywheels and the cylinder system to stop working, such as during times of storms. Additional steps may also be taken to protect the OWEC from damage, such as rotating the spar reflectors and lowering the float below the surface of the water.

Although the invention has been described with reference to specific embodiments thereof, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the spirit or scope of the present invention as defined.

What is claimed is:

1. An ocean wave energy converter (OWEC) system for converting energy created from ocean waves' up and down oscillation into electricity, the system comprising:
a) a spar comprising a vertical shaft affixed to a foundation embedded in the sea floor and extending out of the ocean, wherein the spar comprises reflectors near the sea floor that are configured to re-direct the horizontal wave flow upward;
b) a float affixed to near the top of the spar, at the ocean surface, and comprising parabolic reflectors and buoyancy chambers, wherein the float is configured to rise and fall in-phase with an ocean wave; and,
c) a power takeoff (PTO) device residing on top of the float and comprising a generator for converting waves' oscillations into electricity, wherein the generator comprises two counter-rotating flywheels.

2. The OWEC system of claim 1, further comprising a means housed within the foundation to enable the spar to be vertically raised or lowered.

3. The OWEC system of claim 1, wherein the float parabolic reflectors are configured on the underside of the float to channel water flow vertically against the float.

4. The OWEC system of claim 1, wherein one each buoyancy chamber is configured on opposing ends of the float to support the weight of the float so that about 5% of the float extends above the sea level during normal weather conditions.

5. The OWEC system of claim 1, wherein the spar reflectors comprise rotatable and collapsible members that can be adjusted to maximize the amount of the horizontal wave flow that is re-directed vertically while minimizing the turbulence generated.

6. The OWEC system of claim 1, wherein the PTO generator further comprises two overrunning clutches, a nut, and an oscillating screw, and wherein one flywheel is the generator's stator, and the other flywheel the generator's rotor.

7. The OWEC system of claim 1, wherein the PTO further comprises a computer control system able to electronically communicate with and control the movement of the spar, the spar reflectors, the float, the flywheels, and the cylinder system.

8. The OWEC system of claim 1, further comprising a cylinder system for generating compressed air, and wherein the cylinder system comprises parallel cylinders connected to the underside of the float and configured to suction in and compress atmospheric air when the float moves upward.

9. The OWEC system of claim 8, wherein each of the cylinders further comprises two vertically aligned pistons with springs encircling the pistons.

10. The OWEC system of claim 8, wherein each of the cylinders further comprises an air pressure sensitive check valve configured to pull atmospheric air into the top of each cylinder, and a check valve configured to release compressed air from the bottom of each cylinder for onsite storage.

11. An ocean wave energy converter (OWEC) system for converting energy created from ocean waves' up and down oscillation into electricity and into compressed air, the system comprising:
a) a spar comprising a vertical shaft affixed to a foundation embedded in the sea floor and extending out of the ocean, wherein the spar comprises reflectors near the sea floor that are configured to re-direct the horizontal wave flow vertically;
b) a float affixed to near the top of the spar, at the ocean surface, and comprising two parabolic reflectors on the underside of the float and a buoyancy chambers on each end of the float, wherein the float is configured to rise and fall in-phase with an ocean wave;
c) a power takeoff (PTO) device residing on top of the float and comprising a generator for converting waves' oscillations into electricity, wherein the generator comprises two counter-rotating flywheels; and,
d) a cylinder system for generating compressed air, wherein the system is attached to the underside of the float and is able to suction in atmospheric air when the float moves upward.

12. The OWEC system of claim 11, wherein the spar may be vertically raised or lowered via means housed within the foundation.

13. The OWEC system of claim 11, wherein the float parabolic reflectors are configured on the underside of the float to channel water flow vertically against the float.

14. The OWEC system of claim 11, wherein one each buoyancy chamber is configured on opposing ends of the float to support the weight of the float so that about 5% of the float extends above the sea level during normal weather conditions.

15. The OWEC system of claim 11, wherein the spar reflectors comprise rotatable and collapsible members that can be adjusted to maximize the amount of the horizontal wave flow that is re-directed vertically while minimizing the turbulence generated.

16. The OWEC system of claim 15, wherein the spar reflectors comprise two or three member parabolic shaped reflectors with concave surfaces enabled to be positioned to face horizontal wave flow in normal weather conditions.

17. The OWEC system of claim 11, wherein the cylinder system comprises parallel aligned cylinders, and each cylinder comprises two vertically aligned pistons with springs able to compress the air and release it for onsite storage.

18. The OWEC system of claim 11, wherein the PTO further comprises a computer control system able to electronically communicate with and control the movement of the spar, the spar reflectors, the float, the flywheels, and the cylinder system.

19. The OWEC system of claim 11, wherein the PTO generator further comprises two overrunning clutches, a nut, and an oscillating spar screw, and wherein one flywheel is the generator's stator, and the other flywheel the generator's rotor.

20. The OWEC system of claim 19, wherein each overrunning clutch is configured to connect to a flywheel with the nut only when the flywheel and nut are rotating in the same direction.
